(19) United States
(12) Patent Application Publication
(10) Pub. No.: US 2006/0288969 A1
(43) Pub. Date: Dec. 28, 2006

(54) Engine accessory drive using the outside of a two-sided belt to operate a shrouded cooling fan

(76) Inventor: James A. Thomas, Spencerville, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/159,519

(22) Filed: Jun. 22, 2005

(51) Int. Cl. F01P 7/10; F01P 1/02; F02M 35/02; B63H 1/16

(52) U.S. Cl. 123/41.49; 123/198 E; 123/41.7; 416/179

(57) ABSTRACT

A method of installing an endless accessory drive belt (28) in a motor vehicle powerplant. With a ring shroud (40) in place encircling a fan (16), the belt is trained around a crank pulley (32), a fan pulley (22), and at least one additional pulley (30, 34, 38) without passing the belt through the radial clearance between the fan and the belt. In one embodiment, the outside of the belt trains around the fan pulley, and the inside, around the crank pulley. In another embodiment, the outside of the belt trains around both the fan pulley and the crank pulley.

### FIELD OF THE INVENTION

This invention relates generally to motor vehicle powerplants comprising combustion engines that operate external engine-mounted accessories through accessory drives comprising endless drive belts. More particularly the invention relates to improvements in such accessory drives for operating shrouded cooling fans that draw air through radiators to cool the engines.

### BACKGROUND OF THE INVENTION

A known cooling system for a front engine motor vehicle that is powered by a liquid-cooled internal combustion engine mounted fore and aft in the vehicle, a truck for example, comprises a radiator disposed in front of an engine-driven cooling fan. As motor vehicle emission laws and regulations become more strict, cooling fan performance assumes increased importance because of its influence on control of engine temperature via the cooling system. Fan efficiency can be improved by encircling the fan with a shroud that channels air drawn by the fan through the radiator core toward the fan. In general, fan efficiency increases as the radial clearance between the fan blade tips and the shroud wall is minimized.

The ability to minimize this clearance is however limited by the amount of relative movement between the engine and the radiator. Such movement can occur for various reasons, a principal one of which is that the engine is mounted on the chassis by engine mounts that allow limited movement of the engine relative to the chassis whereas the radiator is typically mounted in a way that allows little or no movement on the chassis.

An engine-mounted ring shroud that forms a downstream section of a shroud and extends forwardly from the engine far enough to encircle the fan blades is useful for enabling the radial clearance to be minimized, but care must be taken to assure some minimum clearance so that the blade tips do not contact the ring shroud wall. An upstream section of the shroud is affixed to the radiator and/or the radiator mounting to channel air to the ring shroud. That upstream section either is constructed in such a way or else is related in some way to the ring shroud to allow for relative motion between the engine and radiator.

An endless belt trained around pulleys is commonly used in automotive and mobile machinery applications to transmit torque from an engine crankshaft to one or more accessory devices, such as the cooling fan, an alternator, a hydraulic fluid pump, and/or an air-conditioning compressor. When such a belt is used to operate a cooling fan, as is typical in truck powerplants, the fan pulley around which the belt is trained is typically disposed inside the area circumscribed by the belt. For increasing surface area contact between the belt and the pulley, the inside of the belt may comprise a series of parallel, endless V-grooves that mesh with matching V-grooves in the pulley. Similar V-grooves are in the other pulleys around which the belt trains.

At an assembly plant, a new belt may be installed and properly tensioned to complete the accessory drive system before a ring shroud is mounted on the engine. However, when the engine has been installed in a motor vehicle and the belt needs to be removed, radial clearance between the fan blade tips and the ring shroud that is less than the maximum thickness of the belt will pose an interference to removal of the belt. Consequently, either the belt must be forced through the clearance during removal, or else the ring shroud must first be removed. If the belt is forced through the clearance, it is possible that the belt could be cut by a blade tip, and while that would not be a problem if the belt were to be scrapped, that possibility should be avoided if the belt is to be re-used. And regardless of whether the belt is to be re-used or a new belt is to be installed, the installation process would still expose either belt to the possibility of being cut while being forced through the clearance during installation.

While removal of the ring shroud would avoid the need to force the belt through the fan-to-shroud clearance, such removal and re-installation obviously require additional time and effort, and may not be done if a service person thinks that the belt can be successfully forced through the clearance without damage, in spite of the inherent potential for belt damage.

Searching conducted in connection with this invention developed patents listed on an accompanying information disclosure statement form.

### SUMMARY OF THE INVENTION

The present invention relates to a novel way of training an endless belt in an accessory drive of a motor vehicle powerplant for relating a fan pulley to a crankshaft pulley. The invention enables a ring shroud to have minimal clearance to the tips of the fan blades while enabling the belt to be installed and removed without having to pass through the fan-to-shroud radial clearance so as to avoid being forced through that clearance when the thickness of the belt is greater than the radial dimension of the clearance.

Accordingly, one generic aspect of the present invention relates to a method of installing an endless belt in a motor vehicle powerplant that has a liquid-cooled combustion engine having a crankshaft for delivering both vehicle propulsion torque and accessory-operating torque and a cooling system through which liquid coolant circulates to cool the engine and which has a radiator where engine heat transferred to circulating coolant is rejected to air drawn through a core of the radiator by a fan operated by the engine.

The powerplant has a ring shroud that is mounted to engine structure and that encircles the fan with radial clearance to the fan, a crank pulley operated by the crankshaft, a fan pulley for operating the fan, and at least one additional pulley. The thickness of the belt is greater than the radial clearance between the ring shroud and the outer perimeter of the fan.

The method comprises, with the ring shroud in place encircling the fan, training the belt around the crank pulley, the fan pulley, and the at least one additional pulley without passing the belt through the radial clearance between the fan and the belt.

Consequently, a further generic aspect of the invention results when the installation of the belt is complete. That further generic aspect is described as a motor vehicle powerplant that comprises a liquid-cooled combustion engine having a crankshaft for delivering both vehicle propulsion torque and accessory-operating torque and a cooling system through which liquid coolant circulates to cool the engine and which comprises a radiator where engine heat transferred to circulating coolant is rejected to air being drawn through a core of the radiator by a fan operated by the engine.

A crank pulley is operated by the crankshaft, and a fan pulley operates the fan. An endless belt operatively couples the crank pulley, the fan pulley, and at least one additional pulley for delivering accessory-operating torque from the crankshaft to the fan pulley to operate the fan. A ring shroud that is mounted to engine structure encircles the fan with radial clearance to the outer perimeter of the fan.

The fan pulley is disposed outside an area circumscribed by the endless belt, and the maximum thickness of the belt is greater than the radial clearance between the ring shroud and the outer perimeter of the fan.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a side elevation view of a motor vehicle powerplant, with a portion broken away for the purpose of illustration, embodying principles of the present invention.

FIG. 2 is view in the direction of arrows 2-2 in FIG. 1.

FIG. 3 is an enlarged cross section view in the direction of arrows 3-3 in FIG. 2.

FIG. 4 is a view similar to FIG. 2 showing a second embodiment.

### DESCRIPTION OF THE PREFERRED EMBODIMENTS

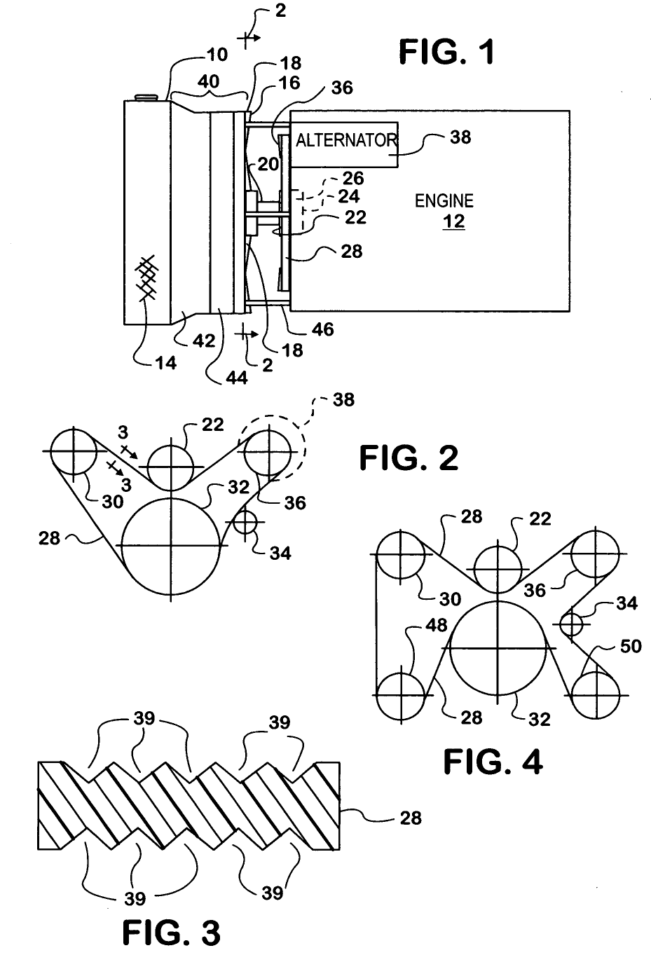

FIG. 1 shows a radiator 10 disposed frontally of an engine 12 in a motor vehicle. Engine 12 is representative of an internal combustion engine having an I- or V-configuration having combustion chambers where fuel is combusted to run the engine for propelling the vehicle.

Radiator 10 is part of the engine cooling system and comprises a core having coolant passages through which engine coolant circulates. As the coolant passes through core 14, air is drawn through the core by an engine-driven fan 16 that is behind radiator 10. As the air is drawn through core 14, heat from the coolant is rejected to the air.

Fan 16 comprises blades 18 radiating from a hub fastened to a shaft 20 that extends forwardly from a pulley 22 that is mounted for rotation on a housing 24 that contains a pump 26 for circulating coolant through the cooling system. An endless belt 28 is trained around not only pulley 22 but also around additional pulleys 30, 32, 34, and 36 to form an accessory-drive system. Pulley 30 is an idler pulley. Pulley 32 is a crank pulley that is fastened to an end of the engine crankshaft. Pulley 34 is an automatic tensioner pulley that tensions belt 28. Pulley 36 is fastened to the shaft of an alternator 38.

When engine 12 is running, the crankshaft rotates pulley 32 to impart travel to tensioned belt 28, which in turn imparts rotation to pulleys 22, 30, 34, and 36 to deliver accessory-operating torque for operating fan 16, pump 26, and alternator 38.

As shown by FIG. 3, belt 28 is what is sometimes called a two-sided belt, meaning that each side has features suited for training around pulleys. In the particular configuration shown in FIGS. 1 and 2, the inside of belt 28 engages pulleys 30, 32, and 36 while the outside of the belt engages pulleys 22 and 34. Hence the latter two pulleys are disposed outside the area circumscribed by belt 28. To increase the contact area of each side of the belt with the respective pulleys, the pulleys are constructed to have a series of side-by-side circular V-grooves while the belt sides are constructed to have a matching pattern of endless side-by-side parallel grooves 39 for meshing with the respective pulleys. Although belt 28 trains around less than a semi-circumference of pulley 22, the increased contact area provided by the multiple grooves can enable a properly tensioned belt 28 to deliver enough torque to operate both fan 16 and pump 26.

A shroud 40 extends between radiator 10 and the front of structure that forms engine 12. The purpose of shroud 40 is to channel air that has been drawn through core 14 toward fan 16 when the fan is being operated by the running engine. Shroud 40 may be considered to comprise several sections in succession. A first section 42 is affixed to radiator 10 and/or the radiator mounting on the vehicle chassis. A second section 44 extends from the first section 42 to a third section 46 that is attached to the engine structure. The first section 42 is relatively rigid, as is the third section 46. The second section 44 has some flexibility to accommodate relative movement between the engine and radiator as discussed above.

The sections 42, 44, 46 are fit together and to radiator 10 to substantially constrain air flowing through the radiator to flow past fan 16. The third section 46 is constructed to fit to the engine structure in a way that provides one or more exit openings for the air to exit from shroud 40. The one or more exit openings also provide clearance to belt 28 and allow the belt to be freely removed from the accessory drive system when the automatic tensioner pulley 34 is moved to a position that releases belt 28 from tension to allow its removal. Similarly, the one or more exit openings allow a belt, either new or used, to be installed.

By providing for the outside of belt 28 to drive fan pulley 22, and by providing for belt 28 to be removed and installed through the exit opening or openings at the rear of shroud 40, radial clearance between the outer perimeter of the fan blades and the wall of the ring shroud can be reduced to allow fan operating efficiency in drawing air through the radiator core to be improved without concern that the reduced clearance would otherwise pose a problem to belt installation and removal and/or potentially damage a belt during removal or installation if the inside of the belt were to drive the fan pulley.

FIG. 4 shows a second embodiment where like reference numerals designate like parts described earlier in connection with FIG. 2. The embodiment of FIG. 4 differs from that of FIGS. 1 and 2 in that the outside of belt 28 trains around crank pulley 32. To accomplish this, two idler pulleys 48, 50 are disposed to respective sides of crank pulley 32 with their axes below that of crank pulley 32.

While a presently preferred embodiment of the invention has been illustrated and described, it should be appreciated that principles of the invention apply to all embodiments falling within the scope of the following claims.

What is claimed is:

1. A method of installing an endless belt in a motor vehicle powerplant that has a liquid-cooled combustion engine having a crankshaft for delivering both vehicle propulsion torque and accessory-operating torque, a cooling system through which liquid coolant circulates to cool the engine and which has a radiator where engine heat transferred to circulating coolant is rejected to air drawn through a core of the radiator by a fan operated by the engine, a ring shroud that is mounted to engine structure and that encircles the fan with radial clearance to the fan, a crank pulley operated by the crankshaft, a fan pulley for operating the fan, and at least one additional pulley, wherein the thickness of the belt is greater than the radial clearance between the ring shroud and the outer perimeter of the fan, the method comprising:
with the ring shroud in place encircling the fan, training the belt around the crank pulley, the fan pulley, and the at least one additional pulley without passing the belt through the radial clearance between the fan and the belt.

2. A method as set forth in claim 1 wherein the ring shroud is constructed for cooperation with the engine structure to provide an exit opening through which air drawn through the ring shroud by the fan exits the ring shroud, and the step of training the belt around the crank pulley is preceded by passing a segment of the belt through the exit opening.

3. A method as set forth in claim 2 wherein at least one additional pulley is a idler pulley that is adjustable to tension the belt, and the method further comprises adjusting the additional pulley to tension the belt after the belt has been trained around the crank pulley, the fan pulley, and the at least one additional pulley.

4. A motor vehicle powerplant comprising:
a liquid-cooled combustion engine having a crankshaft for delivering both vehicle propulsion torque and accessory-operating torque;
a cooling system through which liquid coolant circulates to cool the engine and which comprises a radiator where engine heat transferred to circulating coolant is rejected to air being drawn through a core of the radiator by a fan operated by the engine;
a crank pulley operated by the crankshaft;
a fan pulley for operating the fan; and
an endless belt operatively coupling the crank pulley, the fan pulley, and at least one additional pulley for delivering accessory-operating torque from the crankshaft to the fan pulley to operate the fan; and
a ring shroud that is mounted to engine structure and that encircles the fan with radial clearance to the outer perimeter of the fan;
wherein the fan pulley is disposed outside an area circumscribed by the endless belt, and the maximum thickness of the belt is greater than the radial clearance between the ring shroud and the outer perimeter of the fan.

5. A powerplant as set forth in claim 4 including a further shroud extending from the ring shroud to the radiator for channeling air drawn through the core to the ring shroud.

6. A powerplant as set forth in claim 4 wherein the crank pulley is disposed inside the area circumscribed by the belt.

7. A powerplant as set forth in claim 4 wherein the cooling system comprises a pump that circulates the coolant and that is also operated by the fan pulley.

8. A powerplant as set forth in claim 4 wherein the belt comprises a first set of V-grooves on one side engaging the crank pulley and a second set of V-grooves on the other side engaging the fan pulley.

9. A powerplant as set forth in claim 4 wherein the at least one additional pulley comprises an idler pulley.

10. A powerplant as set forth in claim 4 further including an accessory device also operated by the belt, and wherein the at least one additional pulley comprises a pulley through which the belt operates the accessory device.

11. A powerplant as set forth in claim 4 wherein the belt trains around less than a semi-circumference of the fan pulley.

12. A powerplant as set forth in claim 4 wherein the crank pulley is disposed outside the area circumscribed by the belt.
